(19) United States
(12) Patent Application Publication
(10) Pub. No.: US 2025/0390479 A1
(43) Pub. Date: Dec. 25, 2025

(54) DIVERSE RETRIEVAL IN VECTOR DATABASES USING A MAXIMUM DISPERSION METHOD

(71) Applicant: Seagate Technology LLC, Fremont, CA (US)

(72) Inventors: Zi Jian Wee, Singapore (SG); Hock Soon Lim, Singapore (SG); Frederick Remo Castro, Singapore (SG); Nidhi Narsingh Chaudhary, Singapore (SG); Heonjung Kim, Singapore (SG)

(21) Appl. No.: 18/752,956

(22) Filed: Jun. 25, 2024

(51) Int. Cl. G06F 16/22; G06F 16/242; G06F 16/28

(52) U.S. Cl. CPC G06F 16/2237; G06F 16/2438; G06F 16/285

(57) ABSTRACT

A query vector is directed to a vector database that stores a plurality of vectors that are indexed into a plurality of clusters. In response to receiving the query vector, a furthest vector is found with an approximate maximum distance from the query vector by selecting a furthest cluster having a centroid furthest from the query vector. The query vector and furthest vector are placed into a subset. At least one diverse vector is added into the subset by performing one or more repetitions involving: determining another furthest cluster having another centroid furthest from all vectors in P; selecting another vector from the other furthest cluster that is furthest from all the vectors in P; and inserting the other vector into P. The subset P is used to provide a response to a diversity query.

### SUMMARY

The present disclosure is directed to methods and systems that facilitate diverse retrieval in vector databases using a maximum dispersion algorithm or method. In one embodiment, a method involves receiving a diversity query comprising a query vector v_{c}. The query is directed to a vector database that stores a plurality of vectors that are indexed into a plurality of clusters. In response to receiving the query, a vector vᵣ is found with an approximate maximum distance from v_{c} by selecting a furthest cluster having a centroid furthest from v_{c}, wherein vᵣ is a furthest vector from v_{c} in the furthest cluster. The vectors v_{c} and vᵣ are placed into a subset P and at least one diverse vector is added into P by performing one or more repetitions. The repetitions involve: determining another furthest cluster having another centroid furthest from all vectors in P; selecting another vector from the other furthest cluster that is furthest from all the vectors in P; and inserting the other vector into P. The subset P is used to provide a response to the diversity query.

In another embodiment, a computer system includes one or more processors. The system also includes a client comprising a user interface operable to receive a diversity query from a user. A server of the system includes a vector database that stores a plurality of vectors that are indexed into a plurality of clusters. The system is configured to: form a query vector v_{c} based on the diversity query; find a vector vᵣ with an approximate maximum distance from v_{c} by selecting a furthest cluster having a centroid furthest from v_{c}, wherein vᵣ is a furthest vector from v_{c} in the furthest cluster; place v_{c} and vᵣ into a subset P and add at least one diverse vector into P by performing one or more repetitions. The repetitions involve: determining another furthest cluster having another centroid furthest from all vectors in P; selecting another vector from the other furthest cluster that is furthest from all the vectors in P; and insert the other vector into P. The system is further configured to use the subset P to provide a response to the diversity query.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a block diagram of a system according to an example embodiment;

FIGS. 2 and 3 are listings of algorithms according to example embodiments;

FIG. 4 is a diagram showing database vector clustering according to an example embodiment;

FIG. 5 is a graph showing a dispersed query result according to an example embodiment;

FIG. 6 is a block diagram of system according to another example embodiment; and

FIG. 7 is a flowchart of a method according to an example embodiment.

### DETAILED DESCRIPTION

The present disclosure is generally related to vector databases. Generally, vector databases store and retrieve data in the form of vectors, and act on queries in the form of vectors. While traditional databases receive queries as text strings, a vector database can search any type of data (e.g., binary numbers) represented as a vector, and can perform more powerful pattern matching that can be provided by traditional text queries, e.g., regular expressions.

One emerging use for vector databases is in the field of machine learning. Machine learning models can encode various data as high dimensional vectors, efficiently compressing multi-modal information into lists of numbers. As such, vector databases (e.g. Milvus, Pinecone) have become a popular way to store and retrieve these vectors. Users encode their data (e.g. images or text) into high dimensional vectors and store them into a vector database. The users can then retrieve semantically similar data by querying with an input vector (encoded from an input image or text by the same model). Vector databases are currently designed to efficiently compute the closest vectors (e.g., by Euclidean or cosine distance) in the database to the query vector.

While similarity search is a commonly implemented retrieval method, there is currently no vector database that allows retrieving diverse or dissimilar data from an input query. Generally, a diverse search finds instances that are maximally dispersed from the query vector, as determined by their distance from the query vector and from each other (e.g., by Euclidean or cosine distance). Retrieving diverse data could be useful in cases such as: sampling differing opinions from Twitter/Reddit, sampling interesting events from surveillance footage, sampling diverse candidates from a list of resumes, identifying distinct types of music, etc.

Diversity in a set of vectors can be measured by the minimum distance between any pair of vectors. Maximizing the distance among all possible subsets of vectors will attempt to ensure no two data points in the selected subset are alike, e.g., the vectors returned as results are different than the query vector, as well as being different from one another as much as possible.

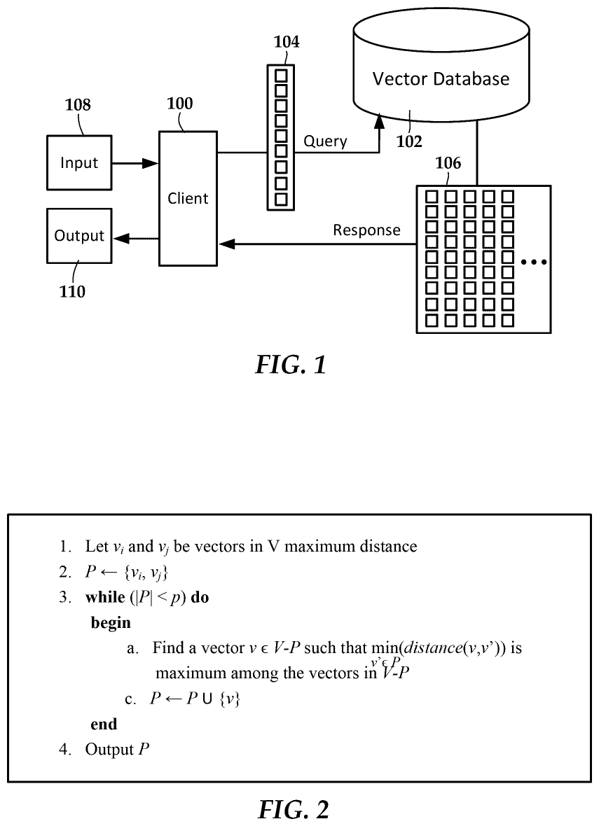

In FIG. 1, a diagram shows a system according to an example embodiment. A client 100 accesses a vector database 102 for operations such as vector storage, vector retrieval, and vector query. The vector database 102 implements an efficient algorithm to retrieve a diverse subset of result vectors 106 in response to a query vector 104. The algorithm aims, via a greedy heuristic, to maximize the minimum pairwise distance of all vectors in a subset that includes the result vectors 106 and the query vector 104. Note that while the vectors 104, 106 are illustrated as 1×9 vectors, the vector database 102 can be configured to store any size and dimension of vectors.

Generally, the client 100 is a software and hardware component operating on the same or different computer than the vector database 102. The client 100 may accept input data 108 (e.g., text, images, audio, video, etc.) that is converted to the query vector 104 by applying a transformation or embedding function to the input data 108. A previous mapping of vectors to data may be used to obtain output data 110 from the result vectors 106.

As noted above, one type of query that can be fulfilled by the vector database 102 is a set of result vectors 106 that are dissimilar from the query vector 104 and each other. One facility dispersion algorithm is known as Gaussian Mixture Model (GMM) and was first described in “Heuristic and special case algorithms for dispersion problems” by Sekharipuram S. Ravi, Daniel J. Rosenkrantz, and Giri Kumar Tayi; Operations research 42.2 (1994): 299-310. The GMM dispersion algorithm is summarized in the listing of FIG. 2.

The GMM algorithm in FIG. 2 approximates the most dispersed p-vectors in a set V of vectors. At step 1, two vectors vᵢ and vⱼ of the set V with maximum distance between each other are found and placed into the subset P at step 2. At each iteration within step 3, a vector v in V-P (all remaining vectors in V not currently in P) is chosen such that the minimum distance from v to a node in P is the largest among all the nodes in V-P. The loop terminates when the size of P is p.

The GMM algorithm provides a performance guarantee of two: the greatest minimum pairwise distance will be no less than half the optimal value. Ravi et al. showed that unless P=NP, no polynomial-time heuristic can provide a better performance guarantee than GMM. Note that the GMM does not take a query vector as input, but rather starts with the pair of vectors vᵢ and vⱼ with maximum distance in V. As such, GMM by itself cannot compute the most diverse subset of vectors to a specific query vector.

The GMM algorithm shown in FIG. 2 does not describe how to efficiently obtain vᵢ and vⱼ in step 1 and v in step 3a. A naive distance comparison between all vectors to get the furthest pair for step 1 will be O(V²) in complexity. Similarly, computing distances between v′∈P and all v∈V-P will be O(P(V−P)) in complexity. Thus, the query speed can be prohibitively expensive for large vector databases.

It is believed that there are currently no vector databases which have implemented GMM or its variants in a diverse vector retrieval feature. There are also believed to be no known techniques attempting to improve the distance computation efficiency. The following provides methods and systems that can provide vector search and retrieval to estimate a most diverse subset of vectors within a set, and do so efficiently.

One feature that provides efficient search results is to index the vector database 102 such that similar vectors are clustered together. To achieve this, indexing data structures are added to the database that link different stored vectors together based on them being grouped into a cluster by a clustering algorithm, e.g., K-means clustering, density based clustering, etc. Both similarity and diversity queries can benefit from clustering of vector databases.

Generally, the clusters are precomputed, such that the indices that define the clusters can be accessed for fast access during queries. As new vectors are added to the vector database 102, the clustering indices are updated based on the clustering algorithm to add new vectors to one or more existing clusters, or possibly to recalculate clusters for more significant changes. Different clustering algorithms and/or clustering parameters can be used to define more than one clustering index, so that the vector database 102 can use a selected clustering arrangement for use in a query. For example, a database of 100,000 vectors could have a large cluster index of 200 clusters each having an average of 500 vectors and a small cluster index of 500 clusters each having an average of 200 vectors. One of these indices could be chosen during the query based on an option provided with the query.

Each of the clusters will have a centroid, e.g., a representative vector that is located approximately in the middle of the cluster. The centroid may be an actual vector in the database or a calculated vector formed from a mathematical combination of the cluster's vectors (e.g., average, median, etc.). The centroid can be used as a proxy for all of the vectors in the cluster, e.g., for approximate nearest neighbor search.

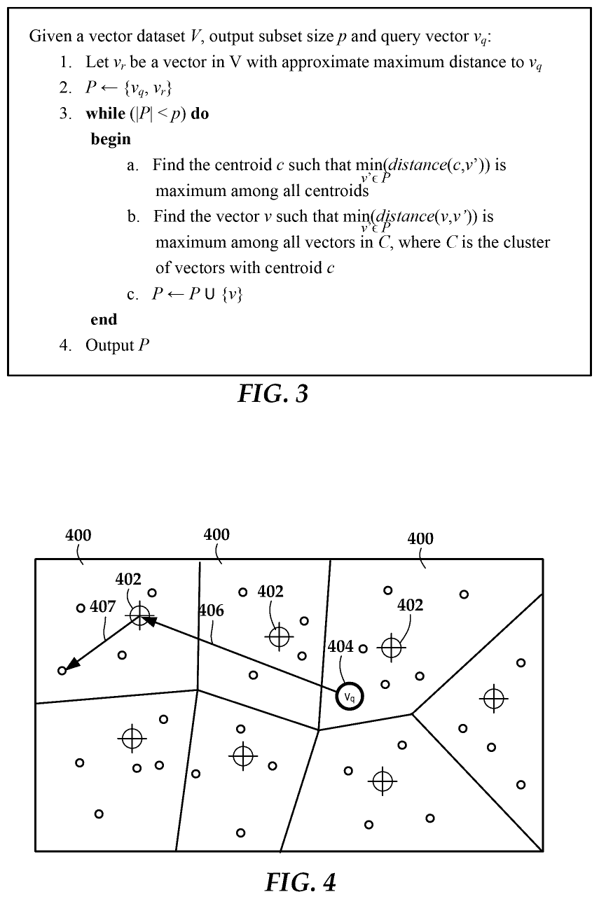

In FIG. 3, a listing shows a modified GMM algorithm to accept an input query vector, and to efficiently compute vector distances via indexing with centroids. To efficiently compute the furthest vector from v_{q} in step 1 of FIG. 3, the algorithm utilizes the above-noted vector database indexing techniques by computing centroids of neighboring vectors via a clustering algorithm.

An example of clustering is shown in the simplified diagram of FIG. 4. The rectangle represents the entire vector space and the partitions each represent different clusters 400. Each cluster has a centroid 402. To retrieve similar vectors, vector databases may compute the closest centroids 402 to a query vector 404 (v_{q}), then compute the closest vectors to these centroids 402. This avoids the heavy computation of calculating the distance between the query vector to all other vectors. However, the resultant nearest neighbors are only approximations, as the algorithm retrieves vectors closest to the centroids rather than the query vector itself.

In embodiments described herein, the cluster centroids are used to obtain the approximate furthest vector to the query vector 404 (v_{q}), which is used in step 1 of FIG. 3. As shown, for example, by the arrows 406, 407 in FIG. 4, the algorithm selects the furthest centroid 402 from the query vector 404, then selects the furthest vector from that centroid. Whereas the complexity of finding the furthest pair of vectors in GMM in step 1 of FIG. 2, is O(V²), the complexity of step 1 in FIG. 3 is O (I+C), where I is the number of centroids in the vector index, and C is the average number of vectors in a cluster.

To improve the efficiency of finding vector v in step 3 of FIG. 3, the same indexing technique is applied to a GMM type of iteration. At step 3a, the algorithm finds a centroid c such that a minimum distance between the centroid and the vectors in P is maximum. Note that this is shown searching among all centroids in the vector index, however may exclude centroids associated with vectors previously added to P, e.g., the centroid used to approximate the maximum distance in step 1. The centroid found at step 3a is associated with a cluster C.

At step 3b, a vector v in the cluster C is found such that such that a minimum distance between the vector v and the vectors in P is maximum among all vectors in C. The vector v is then added to the subset P, and the loop repeats until the size of P is p. Whereas the complexity of step 3 in FIG. 2 is O(P(V−P)) in GMM, the complexity of step 3 in FIG. 3 is O(P(I+C)). For example, a database with 100,000 vectors and P<<V, step 3 of FIG. 2 has complexity O (100,000P). For the same database arranged into 1000 clusters each having an average of 100 vectors, step 3 in FIG. 3 has complexity of O(1,100P), about 0.01 of that using the GMM in FIG. 2.

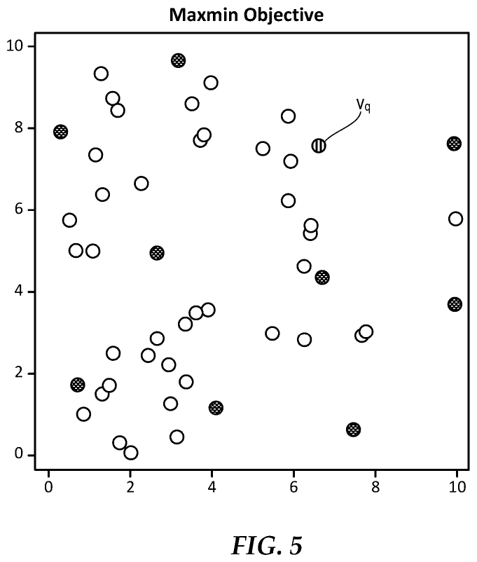

The result of this modified GMM algorithm is shown in the graph of FIG. 5, where the shaded dots represent the maximally dispersed subset of ten vectors including the query vector v_{q}. The shaded dot represent are a subset of ten vectors (including the query vector) that are (approximately) maximally dispersed from one another. When applied to various multi-modal data, this method can efficiently retrieve diverse data such as: movie reviews (e.g., nlp.stanford.edu/sentiment/) and surveillance images (e.g., www.crcv.ucf.edu/projects/real-world/). The retrieved data vectors are semantically dissimilar to the input query vector and to each other.

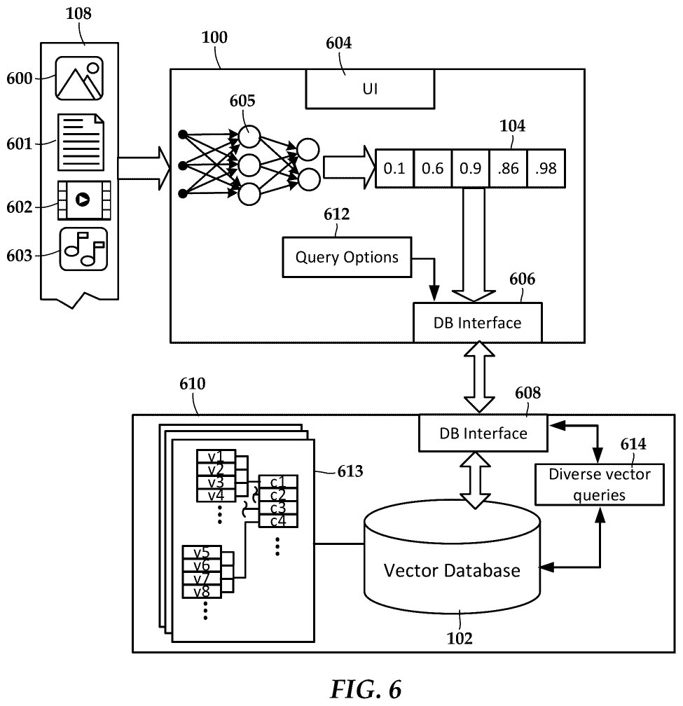

In FIG. 6 a block diagram illustrates details of a system according to example embodiments. As noted above in the description of FIG. 1, a client 100 accepts input data 108 that may include structured or unstructured digital data (e.g., files), such as images 600, text documents 601, video 602, and audio 603. The client 100 can be implemented to operate on one or more conventional computing arrangements including one or more processors, volatile memory, non-volatile memory, input/output (I/O) busses, network interface, and the like. The input data 108 may be transmitted to the client 100 under user commands communicated to the client 100 via a user interface (UI) 604.

The client 100 includes an embedding model 605 that converts the input data 108 to the query vector 104. The embedding model 605 may be implemented as a deep neural network (DNN) that is trained to produce simplified numerical vectors such that similar data objects will have similar vectors. Other machine learning models such as an autoencoder may provide a similar function to the embedding model 605. Note that the embedding model 605 may also be implemented in the server 610, such that the client 100 submits the input data to the server 610 instead of the query vector 104. In other embodiments, the embedding model 605 or equivalents may operate on a third computing entity (not shown) between the client 100 and server 610.

The client 100 includes a database interface 606 used for communicating with a corresponding database interface 608 of the vector database 102, which is shown here operating on a server 610. The server 610 may include the same or different computing hardware than the client 100. The interfaces 606, 608 include common protocols, e.g., defined via an application program interface (API), and may use common inter-process communication (IPC) and/or network protocols to establish communications.

In this example, the query vector 104 is sent to the vector database 102 together with query options 612. The query options 612 may specify which database to use, encoding scheme used for turning data objects in the stored vectors, whether the query is for diversity or similarity to the vector 104, number of results to return, clustering index 613 to use (if more than one index is available), pre-filtering steps, etc. Note that the options 612 could be sent together with the input data 108 over the interfaces 606, 608 instead of with the vector 104. In such an arrangement, the server 610 (or another computing entity) will perform the conversion of the input data 108 to the query vector 104 instead of the client 100, as described above.

If the query is for a diversity search, a diverse query component 614 performs operations described above. The query component 614 interacts with one or more indices 613 (or other data structures) that define clusters of vectors based on similarity. This is represented here by a tree graph, in which each cluster cx is linked with a plurality of vectors vₓ. Different cluster definitions may be used as described above, and the indices may be updated as new data is added to the database 102. The query component 614 performs an algorithm such as shown in FIG. 3 to find a set of query results in the database 102. The query results are returned to the client 100 via the database interfaces 606, 608, e.g., for access via the UI 604.

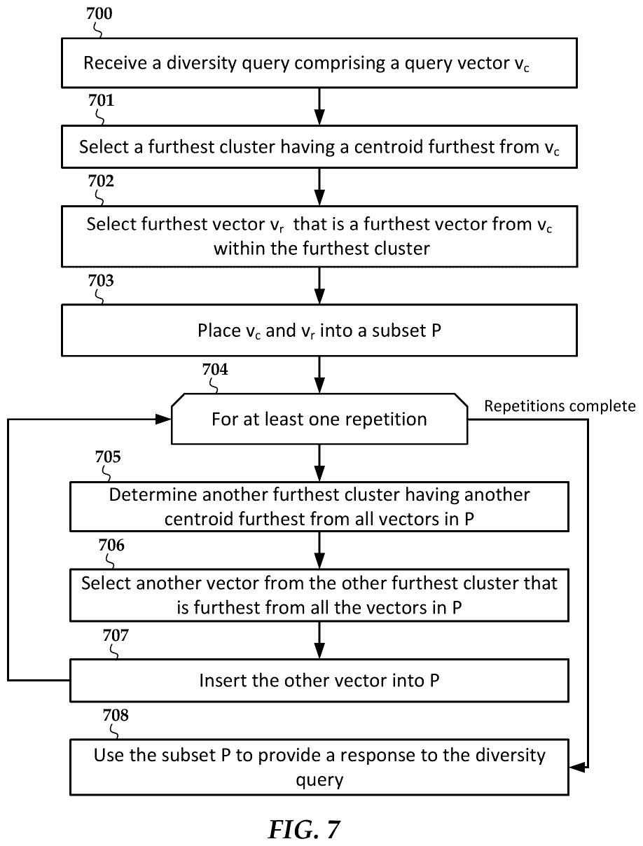

In FIG. 7, a flowchart shows a method according to an example embodiment. The method, which is performed on one or more computers, involves receiving 700 a diversity query comprising a query vector v_{c}. The query is directed to a vector database that stores a plurality of vectors that are indexed into a plurality of clusters. In response to receiving the query, a furthest cluster having a centroid furthest from v_{c}, is selected 701. A furthest vector vᵣ is selected 702, which is a furthest vector from v_{c} in the furthest cluster. Vector vᵣ will have an approximate maximum distance from v_{c} within the database.

At block 703, v_{c} and vᵣ are placed 703 into a subset P. Loop limit 704 represents at least one repetition where at least one diverse vector not already in P is added into P. Each repetition involves determining 705 another furthest cluster having another centroid furthest from all vectors in P. Another vector is selected 706 from the other furthest cluster that is furthest from all the vectors in P, the other vector being inserted 707 into P. The subset P is used to return 708 a response to the diversity query.

In one embodiment, the determining 705 of the other further cluster involves determining that a minimum distance of the other centroid from all of the vectors in P is a maximum. Similarly, the determining 706 of the other vector may comprise determining that a minimum distance of the other vector from all of the vectors in P is a maximum. This generally corresponds to a max-min objective function.

Among other things, the query may define a number of results N to be returned in response to the query. In such a case, the one or more repetitions complete when the size of P=N+1, because the query vector itself will be in P as well as the results. Generally, the method performed in FIG. 7 may be in response to receiving input data that is the subject of the diversity query. In such a case, the method may further involve (not shown) transforming the binary input data to the query vector via an embedding model. In this case, the plurality of vectors in the vector database are obtained by transforming data objects into the corresponding vectors using the embedding model, the data objects belonging to the same embedding model domain as the input data. The type of the input data comprises at least one of text, imagery, video, and audio, to name a few.

Note that the input data and the data objects identified as query results do not have to be of the same type. For example, there are embedding models (such as OpenAI's CLIP) that can encode both text and images into the same vector space. This allows, for example, a text query to be used to search for images, because the text query vector and the image vectors are in the same vector space and their distance can be compared. More recent models (such as Meta's ImageBind) are being developed to add more modalities like audio, thermal, depth, etc.

For example, if the input data is a digital image, the data objects used to form the plurality of vectors in the database are also obtained by transforming a corresponding plurality of data objects of a same or different type using a same embedding model for both. Note that, for data objects of the same type, the data objects don't need to be the same format (e.g., image resolution, color depth), as the embedding model can abstract content of the objects separate from format.

The data returned in response to the query may be the vectors in P and/or a corresponding subset of the data objects stored in the database that are found based on the vectors in P. For example, after each of the objects is transformed into a vector and stored in the database, a reference may be added to the database to link the vector with the object. Generally the diversity query may be submitted via a user interface of a computer (e.g., by submitting a data object which is transformed to the query vector), and wherein the subset P is used to returned to the user via the user interface. For example, what is returned to an end user via a user interface may be not the vectors in P, but the data objects (e.g., text, imagery, video, and/or audio) used to form the vectors in P.

The vector database described in the method of FIG. 7 may have the clusters precomputed before any queries are processed. For example, before receiving 700 the query, data structures that index the plurality of vectors into the plurality of clusters will have already been precomputed. This will speed up the operations, including the determination of centroids of clusters and the member vectors within a cluster. The method the indexing data structures may be formed using one of a K-means clustering or a density based clustering. In some embodiments of FIG. 7, operations that determine furthest distance between centroids and/or vectors (e.g., selecting 702 the vector vᵣ and performing the one or more repetitions 704) involve determining Euclidean distance or cosine distance between two vectors and/or between a selected vector and a selected centroid.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to provide the functions described hereinabove.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination and are not meant to be limiting, but purely illustrative. It is intended that the scope of the invention be limited not with this detailed description, but rather determined by the claims appended hereto.

What is claimed is:

1. A computer-implemented method, comprising:
receiving a diversity query comprising a query vector v_{c}, the query directed to a vector database that stores a plurality of vectors that are indexed into a plurality of clusters;
in response to receiving the query, finding a vector vᵣ with an approximate maximum distance from v_{c} by selecting a furthest cluster having a centroid furthest from v_{c}, wherein vᵣ is a furthest vector from v_{c} in the furthest cluster;
placing v_{c} and vᵣ into a subset P and adding at least one diverse vector into P by performing one or more repetitions comprising:
determining another furthest cluster having another centroid furthest from all vectors in P;
selecting another vector from the other furthest cluster that is furthest from all the vectors in P; and
inserting the other vector into P; and
using the subset P to provide a response to the diversity query.

2. The method of claim 1, wherein determining the other furthest cluster comprises determining that a minimum distance of the other centroid from all of the vectors in P is a maximum.

3. The method of claim 1, wherein determining the other vector comprises determining that a minimum distance of the other vector from all of the vectors in P is a maximum.

4. The method of claim 1, wherein the query defines a number of results N, and wherein the one or more repetitions complete when a size of P=N+1.

5. The method of claim 1, further comprising:
receiving input data that is a subject of the diversity query; and
transforming the input data to the query vector via an embedding model, wherein the plurality of vectors in the vector database are obtained by transforming corresponding data objects into the plurality of vectors using the embedding model, the data objects belonging to a same embedding model domain as the input data.

6. The method of claim 5, wherein the type of the input data comprises at least one of text, imagery, video, and audio.

7. The method of claim 5, further comprising, based on the subset P after the one or more repetitions, returning a subset of the data objects corresponding to the vectors in P.

8. The method of claim 1, further comprising, before receiving the query, precomputing data structures that index the plurality of vectors into the plurality of clusters.

9. The method of claim 8, wherein the precomputing of the data structures comprises using one of a K-means clustering or a density based clustering.

10. The method of claim 1, wherein finding the vector vᵣ and performing the one or more repetitions involve determining Euclidean distance or cosine distance between two vectors and between a selected vector and a selected centroid.

11. The method of claim 1, wherein the diversity query is submitted via a user interface of a computer, and wherein the subset P is used to return the response to the user via the user interface.

12. A computer system comprising one or more processors, the system comprising:
a client comprising a user interface operable to receive a diversity query from a user; and
a server comprising a vector database that stores a plurality of vectors that are indexed into a plurality of clusters;
wherein the system is configured to:
form a query vector v_{c} based on the diversity query;
find a vector vᵣ with an approximate maximum distance from v_{c} by selecting a furthest cluster having a centroid furthest from v_{c}, wherein vᵣ is a furthest vector from v_{c} in the furthest cluster;
place v_{c} and vᵣ into a subset P and add at least one diverse vector into P by performing one or more repetitions comprising:
determining another furthest cluster having another centroid furthest from all vectors in P;
selecting another vector from the other furthest cluster that is furthest from all the vectors in P; and
insert the other vector into P; and
use the subset P to provide a response to the diversity query.

13. The system of claim 12, wherein determining the other furthest cluster comprises determining that a minimum distance of the other centroid from all of the vectors in P is a maximum.

14. The system of claim 12, wherein determining the other vector comprises determining that a minimum distance of the other vector from all of the vectors in P is a maximum.

15. The system of claim 12, wherein the query defines a number of results N, and wherein the one or more repetitions complete when a size of P=N+1.

16. The system of claim 12, further;
wherein the client receives input data that is a subject of the diversity query, wherein the system is operable to transform the input data to the query vector via an embedding model, and wherein the plurality of vectors in the vector database are obtained by transforming corresponding data objects into the plurality of vectors using the embedding model, the data objects belonging to a same embedding model domain as the input data.

17. The system of claim 16, wherein the type of the input data comprises at least one of text, imagery, video, and audio.

18. The system of claim 16, further comprising, based on the subset P after the one or more repetitions, returning a subset of the data objects corresponding to the vectors in P.

19. The system of claim 12, further comprising, before receiving the query, precomputing data structures that index the plurality of vectors into the plurality of cluster, wherein the precomputing of the data structures comprises using one of a K-means clustering or a density based clustering.

20. The system of claim 12, wherein finding the vector vᵣ and performing the one or more repetitions involve determining Euclidean distance or cosine distance between two vectors and between a selected vector and a selected centroid.
